(19) United States
(12) Patent Application Publication
(10) Pub. No.: US 2025/0134010 A1
(43) Pub. Date: May 1, 2025

(54) BACKPACK BLOWER WITH A DISTRIBUTED AIR INLET COVER ASSEMBLY

(71) Applicant: HUSQVARNA AB, Huskvarna (SE)

(72) Inventors: Takashi Oosawa, Kawagoe (JP); Masaaki Sugiyama, Kawagoe (JP); Kazuyuki Kawamura, Kawagoe (JP)

(21) Appl. No.: 18/498,821

(22) Filed: Oct. 31, 2023

(51) Int. Cl. A01G 20/47

(52) U.S. Cl. CPC A01G 20/47

(57) ABSTRACT

An inlet cover assembly for a blower may include a body, a plurality of vents to permit air flow into the fan housing, and an air flow guide plate formed integrally therein to direct air flow inside the inlet cover assembly to the fan assembly. The inlet cover assembly may extend continuously around four sides of the fan assembly. The blower may include a blower tube, a power source, a fan assembly to force air through the blower tube responsive to operation of the power source, and a fan housing disposed around the fan assembly. The fan assembly may define an axis about which a fan thereof rotates.

### TECHNICAL FIELD

Example embodiments generally relate to outdoor power equipment and, more particularly, relate to a backpack blower with an improved air inlet cover assembly.

### BACKGROUND

Blowers are popular outdoor power equipment used for quickly moving debris like leaves, grass, and other loose yard materials using air. Blowers typically utilize a powered fan assembly to pull air into the blower housing through vents, and then recycle and blow the pulled in air back out through a blower tube to help move the debris. The blowers make use of a clearance between the fan assembly and the blower housing, along with the air flow guide plates positioned within the housing to direct air flow, to help maximize the air flow employed by the blower.

For larger tasks, more air flow is required by the blower. To achieve an increase in air flow, blowers typically increase the fan size and the power source (i.e. utilizing a gas/petroleum powered engine or a large battery). However, the size increase of the fan and power source greatly increases the weight of the blower and thus decreasing the maneuverability of the blower tube with a standard handheld blower. In this regard, it is common to place the blower on a backpack assembly so that the operator can carry the weight of the device on his/her back. This makes carrying the device much easier, and the blower tube is typically then able to be easily directed by the operator.

Although such backpack blower devices are very popular, the often larger fan and larger power source comes at the cost of clearance within the blower housing and locations of vents to properly fit and stably secure the necessary components. The lack of clearance results in less efficient airflow and increases the difficulty for air flow guide plates to properly and efficiently direct air flow to the fan assembly.

The standard backpack blower housing thus results in a high air flow speed into the housing being concentrated in a small area, due to the minimal clearance, vents, and air flow guide plate utilization. The high air flow speed into the housing over a relatively small intake area may result with a strong, suction-like effect that may cause debris to stick to the outside of the housing. Debris sticking to the housing results in a reduction in blower efficiency, as well as potentially causing a power source failure due to lack of air flow into the housing and increased strain of the power source. The air flow guide plates also struggle to maximize the reduced air flow to help counteract the airflow loss. Thus, it may be desirable to develop an alternative housing for a backpack blower that could help maximize airflow and efficiency, without concentrating the airflow into the blower to a small area, while maintaining the minimal size required for a backpack blower.

### BRIEF SUMMARY OF SOME EXAMPLES

Some example embodiments may therefore provide an efficient and safe housing for a backpack blower.

In accordance with an example embodiment, a blower may be provided. The blower may include a blower tube, a power source, a fan assembly to force air through the blower tube responsive to operation of the power source, a fan housing disposed around the fan assembly, and an inlet cover assembly comprising a plurality of vents to permit air flow into the fan housing. The fan assembly may define an axis about which a fan thereof rotates. The inlet cover assembly may include an air flow guide plate formed integrally therein to direct air flow inside the inlet cover assembly to the fan assembly, and the inlet cover assembly may extend continuously around four sides of the fan assembly.

In another example embodiment, an inlet cover assembly for a blower may be provided. The inlet cover assembly may include a body, a plurality of vents to permit air flow into the fan housing, and an air flow guide plate formed integrally therein to direct air flow inside the inlet cover assembly to the fan assembly. The inlet cover assembly may extend continuously around four sides of the fan assembly. The blower may include a blower tube, a power source, a fan assembly to force air through the blower tube responsive to operation of the power source, and a fan housing disposed around the fan assembly. The fan assembly may define an axis about which a fan thereof rotates.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective back view of a blower having a starting assembly in accordance with an example embodiment;

FIG. 2 illustrates a right side view of a blower having a starting assembly in accordance with an example embodiment;

FIG. 3 illustrates a back side view of an inlet cover assembly in accordance with an example embodiment;

FIG. 4 illustrates a first side view of an inlet cover assembly in accordance with an example embodiment;

FIG. 5 illustrates a top side view of an inlet cover assembly in accordance with an example embodiment;

FIG. 6 illustrates a bottom side view of inlet cover assembly in accordance with an example embodiment;

FIG. 7A illustrates a perspective view of an inlet cover assembly in accordance with an example embodiment; and

FIG. 7B illustrates a perspective view of an inlet cover assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein provide an improved housing for a backpack blower. In this regard, some example embodiments may provide for improved housing with a plurality of vents and an integrated air flow guide plate to improve airflow efficiency by distributing the airflow into the blower over a larger area. This may decrease the flow rate of the airflow into the blower at any given area, which may therefore decrease the amount of debris that may stick to an exterior of the housing that may negatively impact airflow. Thus, the durability and the maximum run time of the backpack blower may both increase due to the improved airflow efficiency. As a result, users may find operability of the backpack blower to be enhanced, and the user experience may also be improved.

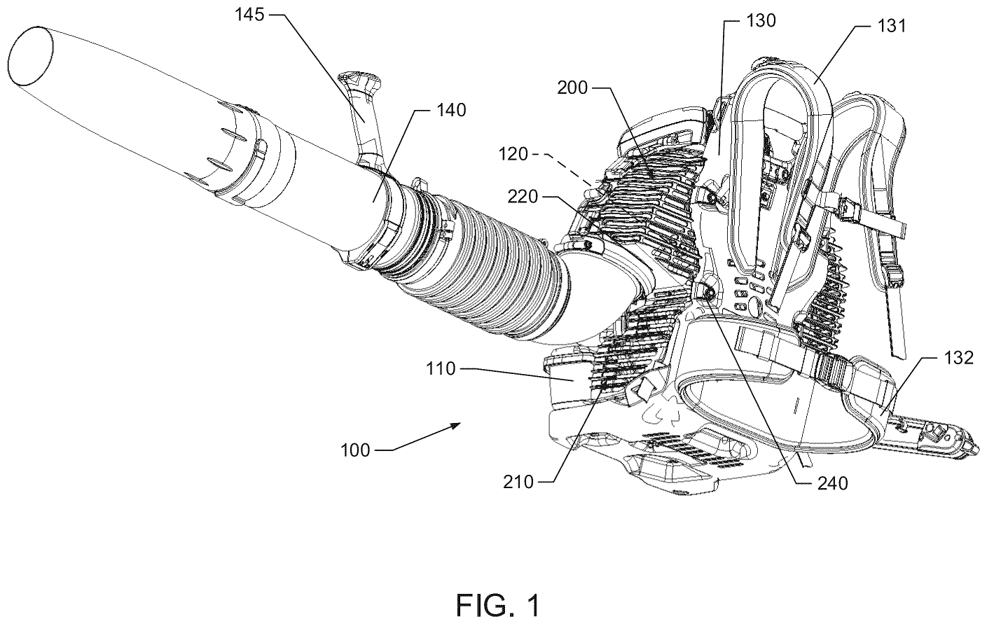

FIG. 1 illustrates a perspective back view of a backpack blower (hereinafter simply referred to as blower 100) in accordance with an example embodiment. Referring to FIG. 1, the blower 100 may include a fan housing 110, inside which various components of the blower 100 may be housed. The blower 100 may further include a power source for providing the driving force to move air through the blower 100. In this regard, the operation of the power source may in turn power a fan assembly 120 that may drive air out of the blower 100. The fan assembly 120 may be disposed within the fan housing 110. In some embodiments, the power source may be a gasoline or petrol engine, a battery, or any number of power sources that may be housed in the fan housing 110. The blower 100 may be worn on the operator's back and supported via a backpack harness 130.

The fan housing 110 may be formed of plastic, composite materials, metals or any other desirable materials. The backpack harness 130 may include shoulder straps 131 and support structures 132 that may integrate with, provide a support platform for, or otherwise enable the weight of the fan housing 110 and the power source to be carried by the backpack harness 130 while the user has donned the blower 100. The user can slip the shoulder straps 131 of the backpack harness 130 off in order to doff the blower 100.

In an example embodiment, the blower 100 may further include a blower tube 140 that may be operably coupled to the fan assembly via a flexible hose. Air pulled into the blower 100 and driven through the fan assembly 120 may be output into the hose and then be directable via the blower tube 140 by manual pointing of the blower tube 140 by the user. In some cases, the blower tube 140 may include a handle 145 that, in some cases, may include a trigger or other type of actuator that may be operable by a finger of the user while the user holds the handle 145. Actuation of the trigger may cause power from the power source to turn the fan assembly 120 and drive air through the blower 100.

The blower 100 may additionally include an inlet cover assembly 200. The inlet cover assembly 200 may have a plurality of vents 210 which may permit and encourage air flow into the inlet cover assembly 200. In some cases, the plurality of vents 210 may be disposed on some or all sides of the inlet cover assembly 200. The inlet cover assembly 200 may cover an inlet (not shown) to direct air drawn in through the plurality of vents 210 into the fan housing 100 towards the fan assembly 120. Air drawn through the inlet into the fan housing 110 may then be ejected by the fan assembly 120 through the blower tube 140.

In an example embodiment, the inlet cover assembly 200 may include an air flow guide plate 220. In some cases, the air flow guide plate 220 may be formed integrally with the inlet cover assembly 200. The air flow guide plate 220 may direct the air flow that has entered the inlet cover assembly 200 through the plurality of vents 210 and into the fan housing 110 via the inlet. In some cases, the air flow guide plate 220 may direct air flow entered through some or all of the plurality of vents 210 into the inlet. In an example embodiment, the inlet cover assembly 200 may include multiple air flow guide plates 220. In some cases, multiple inlets may be covered by the inlet cover assembly 200. The multiple air flow guide plates 220 may direct air flow into a single inlet or direct air into multiple inlets.

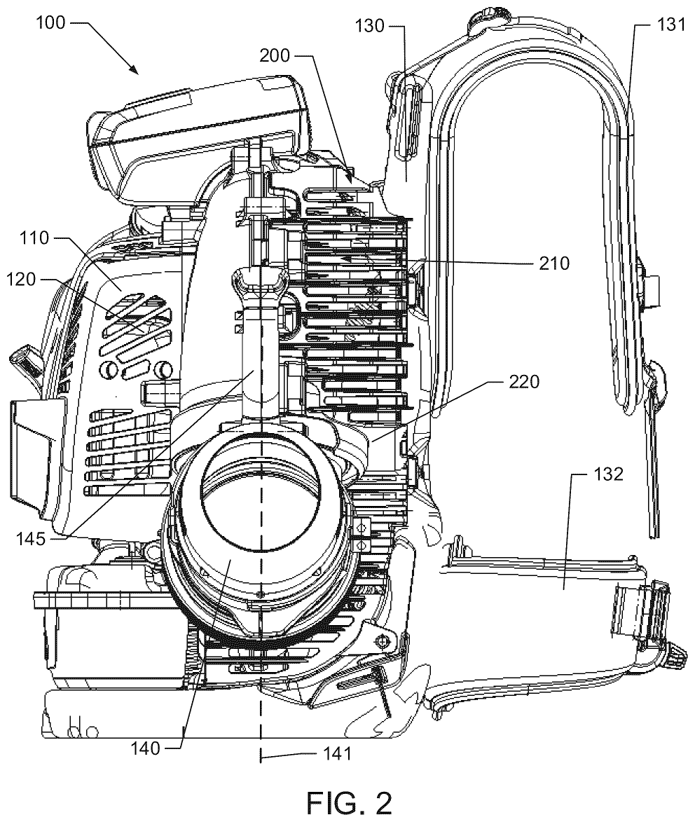

FIG. 2 illustrates a right side view of the blower 100. In some cases, the fan housing 110 and the inlet cover assembly 200 may be disposed primarily on opposite sides of a midplane 141 of the blower tube 140. The right side view of FIG. 2 displays how the fan assembly 120 may be disposed within the fan housing 110. In some cases, the inlet or inlets (not shown) may be the only direct route for air flow between the inlet cover assembly 200 and the fan housing 110.

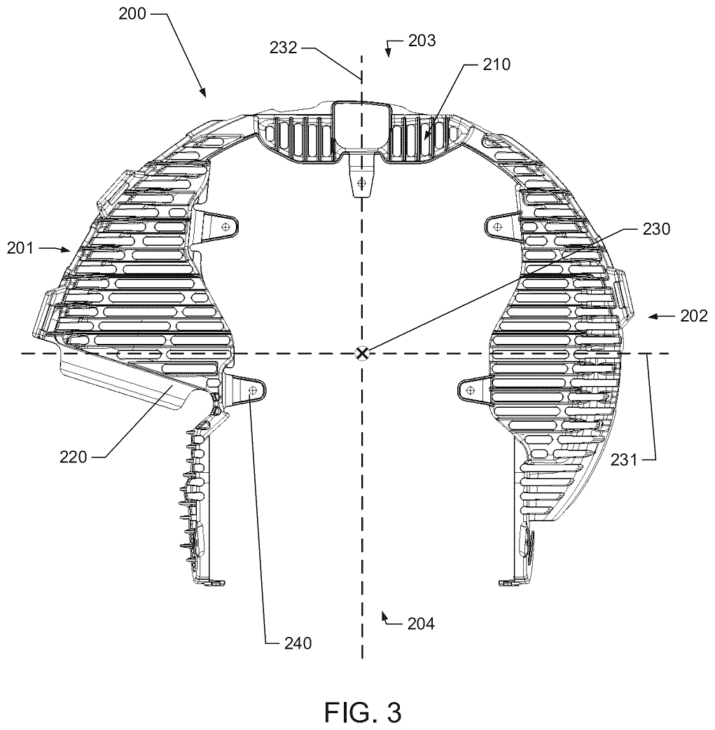

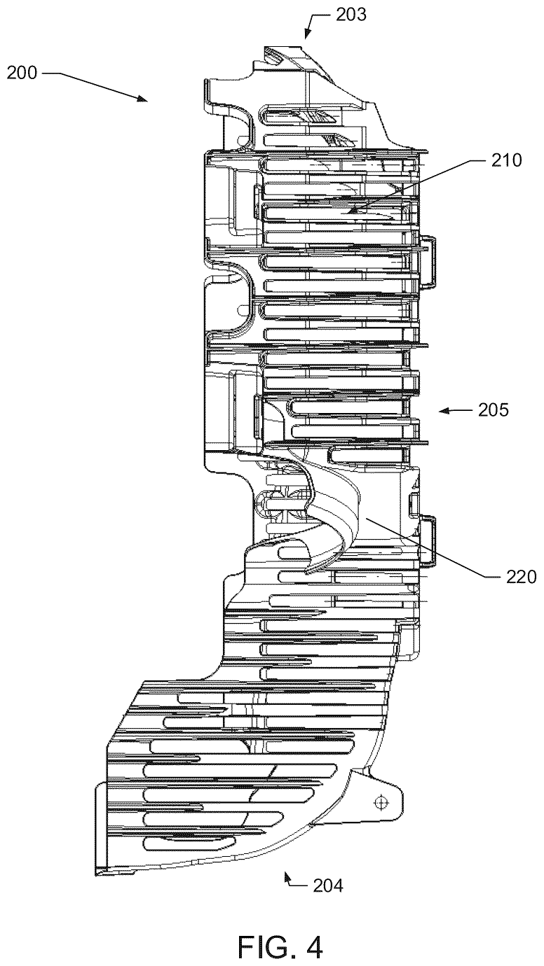

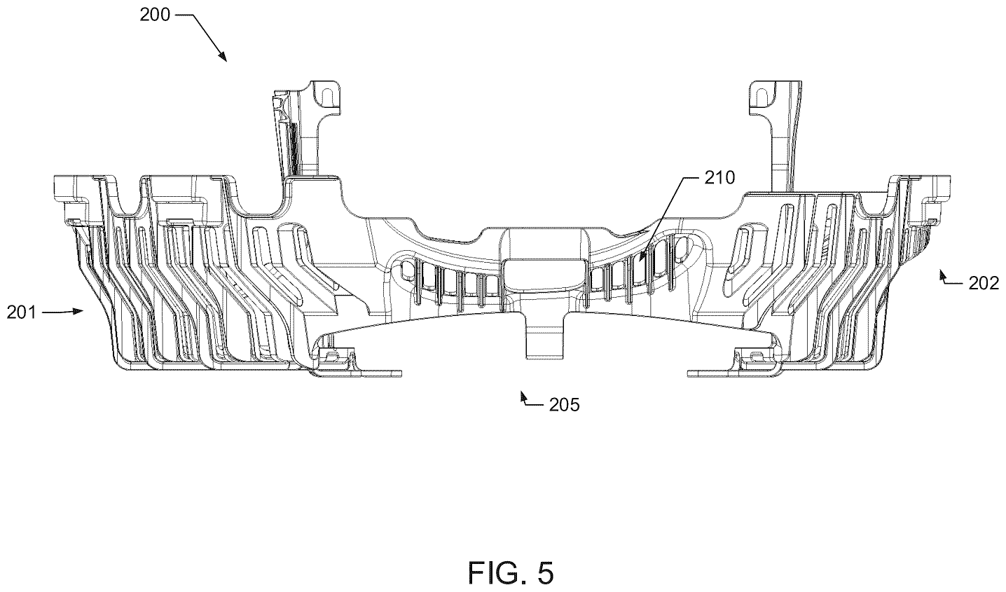

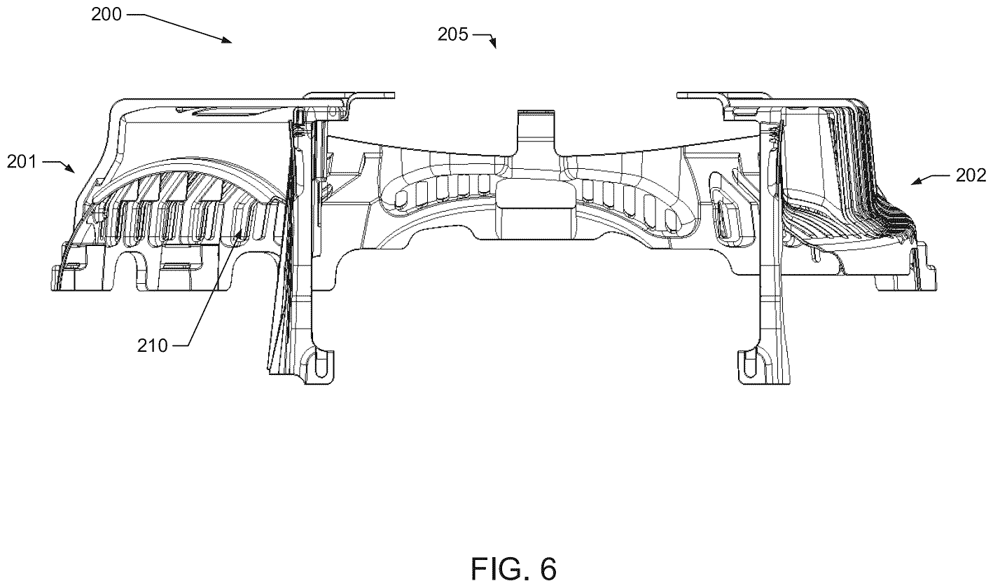

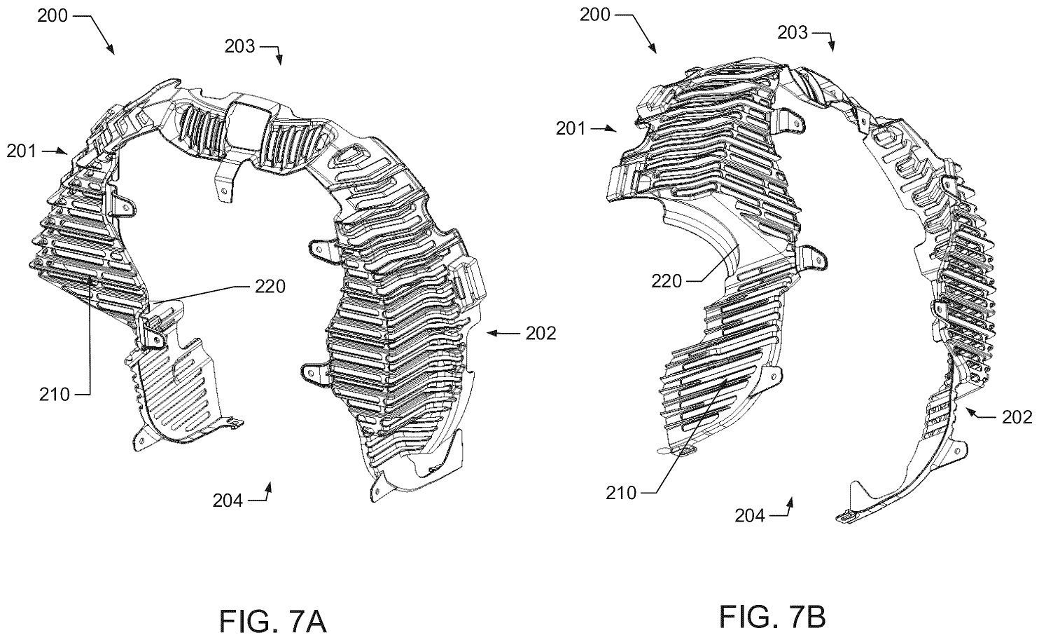

FIG. 3 illustrates a back side view of an inlet cover assembly 200. FIG. 4 illustrates a first side view of an inlet cover assembly 200. FIG. 5 illustrates a top side view of an inlet cover assembly 200. FIG. 6 illustrates a bottom side view of inlet cover assembly 200. FIG. 7 illustrates perspective views of an inlet cover assembly 200.

As shown in FIGS. 3-7, the inlet cover assembly 200 may include five distinct sides on its exterior. The inlet cover assembly 200 may include a first side 201, second side 202, top side 203, bottom side 204, and back side 205. In some cases, the inlet cover assembly 200 may be horizontally bisected by a horizontal plane 231. The horizontal plane 231 may extend through an axis 230, about which, a fan of the fan assembly 120 may rotate. In an example embodiment, the inlet cover assembly 200 may also be vertically bisected by a vertical plane 232. The vertical plane 232 may also extend through the axis 230 about which the fan of the fan assembly may rotate.

In some cases, the horizontal plane 231 may pass through the inlet cover assembly 200 at three sides. For instance, the horizontal plane 231 may pass through the first side 201, the second side 202, and the back side 205 of the inlet cover assembly 200. In an example embodiment, the vertical plane 232 may pass through the inlet cover assembly 200 at two sides. For instance, the vertical plane 232 may pass through the top side 203 and the back side 205 of the inlet cover assembly 200. In some cases, the air flow guide plate 220 may direct air towards the horizontal plane 231 into the inlet from multiple directions. For example, the air flow guide plate 220 may direct some air upward towards the horizontal plane 231 into the inlet and downward towards the horizontal plane 231 into the inlet. For instance, air entering the plurality of vents 210 on the top side 203 of inlet cover assembly 200 may be directed by the air flow guide plate 220 downward towards the horizontal plane 231 into the inlet, and air entering the plurality of vents 210 on the bottom half of the first side 201 may be directed by the air flow guide plate 220 upward towards the horizontal plane 231 into the inlet. In some cases, air entering the plurality of vents 210 on the second side 202 may be directed by the air flow guide plate 220 either upward or downward towards the horizontal plane 231 into the inlet. In an example embodiment, air entering the plurality of vents 210 may be directed or flow in a clockwise or a counter clockwise direction within the inlet cover assembly 200 towards the inlet.

High air flow rate into the inlet cover assembly 200 may result in an increased likelihood of debris sticking to the outside of inlet cover assembly 200 and being held there by the air flow into the blower 100. Thus, increasing the number of sides of the inlet cover assembly 200 that may have a plurality of vents 210, as well as increasing the surface area of the inlet cover assembly 200 that may be occupied by the plurality of vents 210, may decrease the air flow rate through each individual vent, thus decreasing the chance of debris sticking to the inlet cover assembly 200. The volumetric flow rate of the air may be defined as the product of the flow velocity of the air and the total area through which the air may flow. Thus, by increasing the total effective area that air may flow through to enter the blower 100, the flow velocity of the air may be decreased without impacting the overall volumetric flow rate of air into the blower 100. Therefore, the increase in the plurality of vents 210 and the locations of the plurality of vents 210 may promote an even distribution of air flow rate into the inlet cover assembly 200 throughout the plurality of vents 210. The air flow guide plate 220 may concentrate air flow into the inlet while ensuring a desired air flow rate into the inlet may be maintained for effective blower 100 operation. The air flow guide plate 220 may further distribute the air flow into the inlet cover assembly 200 by partially covering the inlet, which may lower the air flow rate though the plurality of vents 210 closest to the inlet compared to if the air flow guide plate 220 was not present. The air flow guide plate 220 may increase efficiency of the air flow into the inlet due to maximizing the air flow through each individual vent.

In some cases, the inlet to direct air from the inlet cover assembly 200 into the fan housing 110 may be embodied by any number of shapes. For instance, the inlet may be a substantially straight connection between the inlet cover assembly 200 and fan assembly 120. In an example embodiment, the inlet may be a 90-degree elbow connection. In some cases, the inlet may be a diagonal connection. The inlet may be any number of shapes to increase efficiency and air flow through the inlet into the fan housing 110.

In an example embodiment, the plurality of vents 210 may be substantially parallel with the horizontal plane 231. In some cases, the plurality of vents 210 may be substantially parallel with the vertical plane 232. The plurality of vents 210 may be orientated differently based on their location on a specific side of the inlet cover assembly 200. For instance, on the first side 201 and the second side 202 of inlet cover assembly 200, the plurality of vents 210 may be substantially parallel with the horizontal plane 231. On the top side 203 of the inlet cover assembly 200, the plurality of vents 210 may be substantially parallel with the vertical plane 232. On the back side 205 of the inlet cover assembly 200, some of the plurality of vents 210 may be substantially parallel with the horizontal plane 231, and some of the plurality of vents 210 may be substantially parallel with the vertical plane 232. The orientation of the plurality of vents 210 may reduce air flow rate through individual vents and prevent the sticking of debris on the outside of the inlet cover assembly 200 during blower 100 operation, as sticking debris may cause power source failure or reduced fan assembly efficiency.

In some cases, the orientation of the air flow guide plate 220 may be adjusted. The orientation of the air flow guide plate 220 may be angled between about 5 degrees and about 40 degrees relative to the horizontal plane 231. Varying the angle of air flow guide plate 220 orientation may adjust the manner in which the air flow guide plate 220 may direct air flow into the inlet. The air flow guide plate 220 may be positioned near where the blower tube 140 may be operably coupled to the blower 100. In an example embodiment, the angle of air flow guide plate 220 orientation may improve the operable coupling of the blower tube 140 and the blower. In some cases, the air flow guide plate 220 may be arcuate to conform to the shape of the blower tube; however, in other example embodiments, the air flow guide plate 220 may be embodied by any number of shapes. For example, the air flow guide plate 220 may be flat, circular, acute, or any number of shapes to conform to the necessary structure of the blower 100 and the inlet cover assembly 200.

In an example embodiment, inlet cover assembly 200 may be a unitary piece. The air flow guide plate 220 may be formed integrally with the inlet cover assembly 200. The inlet cover assembly 200, and thus the air flow guide plate 220 may be formed via injection molding or any number of manufacturing techniques to ensure stability and detail of the inlet cover assembly 200. The inlet cover assembly 200 may be constructed of polyamide or nylon. For instance, the inlet cover assembly 200 may be plastic PA6. Integrating the air flow guide plate 220 with the inlet cover assembly 200 may improve air flow via ensuring proper placement of the air flow guide plate 220 relative to the inlet and inlet cover assembly 200. With the limited clearance within the inlet cover assembly 200, integrating the air flow guide plate 220 may improve convenience in assembly and maintenance of the blower 100. In some cases, the integration of the air flow guide plate 220 may help reduce production cost via simplification of manufacturing of the blower 100. In an example embodiment, the integration of the air flow guide plate 220 may improve air flow during blower 100 via increasing clearance within the inlet cover assembly 200 due to the lack of attachment mechanism required for air flow guide plate 220 instillation.

In some cases, the inlet cover assembly 200 may extend continuously around the fan assembly 120. In an example embodiment, the inlet cover assembly 200 extends around the fan assembly 120 on at least four sides thereof. For instance, the first side 201, the second side 202, the top side 203, and the back side 205 of inlet cover assembly 200 may extend around the fan assembly. The perimeter of the inlet cover assembly 200 may be embodied by any number of shapes. For example, the perimeter of inlet cover assembly 200 may be substantially circular, square, spherical, or any number of shapes to increase efficiency of the blower 100. In some cases, the inlet cover assembly 200 may extend around sides of the backpack harness 130. In an example embodiment, the inlet cover assembly 200 may be operably coupled to the backpack harness.

In an example embodiment, the inlet cover assembly 200 may be detachable from the blower 100. In some cases, the inlet cover assembly 200 may be operably coupled and detachable from the blower 100 in any number of ways. For example, the inlet cover assembly 200 may be operably coupled and detachable from the blower via a fastener, such as screws, nuts and bolts, clips, latches, magnets, or any number of ways to safely secure the inlet cover assembly 200 to the blower 100 during operation and use.

A blower of an example embodiment may be provided. The blower may include a blower tube, a power source, a fan assembly to force air through the blower tube responsive to operation of the power source, a fan housing disposed around the fan assembly, and an inlet cover assembly comprising a plurality of vents to permit air flow into the fan housing. The fan assembly may define an axis about which a fan thereof rotates. The inlet cover assembly may include an air flow guide plate formed integrally therein to direct air flow inside the inlet cover assembly to the fan assembly, and the inlet cover assembly may extend continuously around four sides of the fan assembly.

The blower of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, a horizontal plane may extend through the axis and may bisects the inlet cover assembly horizontally. In some cases, a vertical plane may extend through the axis and may bisect the inlet cover assembly vertically. In an example embodiment, the horizontal plane may pass through the inlet cover assembly on three sides and the vertical plane may pass through the inlet cover assembly on two sides. In some cases, the air flow guide plate may direct at least some air up towards the horizontal plane into an inlet, and down towards the horizontal plane into the inlet. In an example embodiment, a perimeter of the inlet cover assembly may be substantially circular. In some cases, a portion of the air flow guide plate may be arcuate to conform to the shape of the blower tube. In an example embodiment, the inlet cover assembly may be detachable from the housing. In some cases, the blower may include a backpack harness operably coupled to the blower to support the blower on a back of a user wearing the backpack harness and the inlet cover assembly may extend around sides of the backpack harness. In an example embodiment, the air flow guide plate of the inlet cover assembly may be at an angle between 5 degrees and 40 degrees relative to the horizontal plane. In some cases, the inlet cover assembly may be a unitary piece. In an example embodiment, the inlet cover assembly may be molded as the unitary piece from polyamide or nylon.

An inlet cover assembly for a blower may be provided. The inlet cover assembly may include a body, a plurality of vents to permit air flow into the fan housing, and an air flow guide plate formed integrally therein to direct air flow inside the inlet cover assembly to the fan assembly. The inlet cover assembly may extend continuously around four sides of the fan assembly. The blower may include a blower tube, a power source, a fan assembly to force air through the blower tube responsive to operation of the power source, and a fan housing disposed around the fan assembly. The fan assembly may define an axis about which a fan thereof rotates.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A blower comprising:
a blower tube,
a power source,
a fan assembly to force air through the blower tube responsive to operation of the power source, the fan assembly defining an axis about which a fan thereof rotates;
a fan housing disposed around the fan assembly,
an inlet cover assembly comprising a plurality of vents to permit air flow into the fan housing,
wherein the inlet cover assembly includes an air flow guide plate formed integrally therein to direct air flow inside the inlet cover assembly to the fan assembly, and
wherein the inlet cover assembly extends continuously around four sides of the fan assembly.

2. The blower of claim 1, wherein a horizontal plane extends through the axis and bisects the inlet cover assembly horizontally,
wherein a vertical plane extends through the axis and bisects the inlet cover assembly vertically, and
wherein the horizontal plane passes through the inlet cover assembly on three sides and the vertical plane passes through the inlet cover assembly on two sides.

3. The blower of claim 2, wherein the air flow guide plate directs at least some air up towards the horizontal plane into an inlet, and down towards the horizontal plane into the inlet.

4. The blower of claim 2, wherein the air flow guide plate of the inlet cover assembly is at an angle between 5 degrees and 40 degrees relative to the horizontal plane.

5. The blower of claim 1, wherein a perimeter of the inlet cover assembly is substantially circular.

6. The blower of claim 1, wherein a portion of the air flow guide plate is arcuate to conform to a shape of the blower tube.

7. The blower of claim 1, wherein the inlet cover assembly is detachable from the housing.

8. The blower of claim 1, further comprising a backpack harness operably coupled to the housing to support the blower on a back of a user wearing the backpack harness,
wherein the inlet cover assembly extends around sides of the backpack harness.

9. The blower of claim 1, wherein the inlet cover assembly is a unitary piece.

10. The blower of claim 9, wherein the inlet cover assembly is molded as the unitary piece from polyamide or nylon.

11. An inlet cover assembly for a blower, the blower comprising:
a blower tube,
a power source,
a fan assembly to force air through the blower tube responsive to operation of the power source, the fan assembly defining an axis about which a fan thereof rotates; and
a fan housing disposed around the fan assembly,
wherein the inlet cover assembly further comprises:
a body,
a plurality of vents to permit air flow into the fan housing, and
an air flow guide plate formed integrally therein to direct air flow inside the inlet cover assembly to the fan assembly,
wherein the inlet cover assembly extends continuously around four sides of the fan assembly.

12. The inlet cover assembly of claim 11, wherein a horizontal plane extends through the axis and bisects the inlet cover assembly horizontally,
wherein a vertical plane extends through the axis and bisects the inlet cover assembly vertically, and
wherein the horizontal plane passes through the inlet cover assembly on three sides and the vertical plane passes through the inlet cover assembly on two sides.

13. The inlet cover assembly of claim 12, wherein the air flow guide plate directs at least some air up towards the horizontal plane into an inlet, and down towards the horizontal plane into the inlet.

14. The inlet cover assembly of claim 12, wherein the air flow guide plate of the inlet cover assembly is at an angle between 5 degrees and 40 degrees relative to the horizontal plane.

15. The inlet cover assembly of claim 11, wherein a perimeter of the inlet cover assembly is substantially circular.

16. The inlet cover assembly of claim 11, wherein a portion of the air flow guide plate is arcuate to conform to a shape of the blower tube.

17. The inlet cover assembly of claim 11, wherein the inlet cover assembly is detachable from the housing.

18. The inlet cover assembly of claim 11, wherein the blower comprises a backpack harness operably coupled to the housing to support the blower on a back of a user wearing the backpack harness, and
wherein the inlet cover assembly extends around sides of the backpack harness.

19. The inlet cover assembly of claim 11, wherein the inlet cover assembly is a unitary piece.

20. The inlet cover assembly of claim 19, wherein the inlet cover assembly is molded as the unitary piece from polyamide or nylon.
